(19) United States
(12) Patent Application Publication
(10) Pub. No.: US 2023/0405512 A1
(43) Pub. Date: Dec. 21, 2023

(54) SORBENT MATERIAL COMPOSITE ARTICLE FOR ADSORPTION

(71) Applicant: W. L. Gore & Associates, Inc., Newark, DE (US)

(72) Inventors: Edward H. Cully, Clarksville, VA (US); Timothy E. Johnston, Asheville, NC (US); Christine M. Scotti, Newark, DE (US)

(21) Appl. No.: 18/199,506

(22) Filed: May 19, 2023

Related U.S. Application Data
(60) Provisional application No. 63/343,758, filed on May 19, 2022.

(51) Int. Cl. B01D 53/04; B01D 53/06; B01D 53/26

(52) U.S. Cl. CPC B01D 53/0454; B01D 53/06; B01D 53/0407; B01D 53/261; B01D 2258/06; B01D 2259/40083; B01D 2253/25; B01D 2253/34; B01D 2257/504; B01D 2259/40088

(57) ABSTRACT

A direct air capture (DAC) device and methods of controlling the same are disclosed herein. The DAC device includes a plurality of contactor elements that are aligned with respect to each other to facilitate homogenous drying and have a plurality of spacings located therebetween such that each of the contactor elements defines a contactor volume and each of the spacings defines a spacing volume. The DAC device has a total volume defined by the contactor volumes and the spacing volumes such that the DAC device is modifiable to (a) reduce the total volume for the contactor elements to facilitate desorption of one or more components of a feed stream and (b) increase the total volume for the contactor elements to facilitate adsorption of the one or more components of the feed stream.

### CROSS-REFERENCE TO RELATED APPLICATION

This application claims the benefit of U.S. Provisional Application No. 63/343,758, filed May 19, 2022, which is incorporated herein by reference in its entirety for all purposes.

### FIELD

The present disclosure relates to a sorbent material composite article, methods of forming and using the same for adsorption, including adsorption for direct air capture (DAC) of carbon dioxide (CO₂).

### BACKGROUND

Increasing carbon dioxide (CO₂) levels associated with greenhouse gas emission are shown to be harmful to the environment. As reported by the Climate.gov article “Climate Change: Atmospheric Carbon Dioxide,” the 2019 average CO₂ level in the atmosphere was 409.8 ppm, the highest level that has been noted in the past 800,000 years. The rate of increase of CO₂ in the atmosphere is also reported to be much higher than the rates in previous decades.

In order to limit climate change to acceptable levels, it is not only necessary to reduce CO₂ emissions in the near future to zero but also to achieve negative CO₂ emissions. Several possibilities exist in order to achieve negative emissions, e.g. combustion of biomaterials for the generation of electricity combined with CO₂ capture from the combustion flue gas and subsequent CO₂ sequestration (BECCS) or direct air capture (DAC) of CO₂.

Capturing CO₂ directly from the atmosphere, referred to as DAC, is one of several means of mitigating anthropogenic greenhouse gas emissions and has attractive economic perspectives as a non-fossil, location-independent CO₂ source for the commodity market and for the production of synthetic fuels. The specific advantages of CO₂ capture from the atmosphere include: a) DAC can address the emissions of distributed sources (e.g. vehicles . . . land, sea and air), which account for a large portion of the worldwide greenhouse gas emissions and can currently not be captured at the site of emission in an economically feasible way; b) DAC can address legacy emissions and can therefore create truly negative emissions, and c) DAC systems do not need to be attached to the source of emission but may be location independent and can be located at the site of further CO₂ processing or usage.

There is increasing motivation to develop and improve upon these processes to make them more efficient, maximizing the amount of CO₂ removed from the atmosphere while minimizing the energy required in the process.

### SUMMARY

A direct air capture (DAC) device and methods of controlling the same are disclosed herein. In one example (“Example 1”), the DAC device includes a plurality of contactor elements that are aligned with respect to each other to facilitate homogenous drying and have a plurality of spacings located therebetween such that each of the contactor elements defines a contactor volume and each of the spacings defines a spacing volume. The DAC device has a total volume defined by the contactor volumes and the spacing volumes such that the DAC device is modifiable to (a) reduce the total volume for the contactor elements to facilitate desorption of one or more components of a feed stream and (b) increase the total volume for the contactor elements to facilitate adsorption of the one or more components of the feed stream. The homogenous drying capability allows the DAC device to more quickly and efficiently complete each adsorption or desorption cycle, since efficiency of the DAC device is reduced when portions of the contact elements are still wet when the next cycle begins.

In another example (“Example 2”) further to Example 1, the DAC device includes a plurality of flexible connection components disposed in the plurality of spacings.

In another example (“Example 3”) further to Example 2, the flexible connection components are spring components that exert reactionary force in response to the total volume being reduced in an opposite direction.

In another example (“Example 4”) further to Example 3, the spring components comprise at least one leaf spring spacer.

In another example (“Example 5”) further to Example 3, the spring components comprise at least one coil spring.

In another example (“Example 6”) further to Example 2, the flexible connection components are hinge components.

In another example (“Example 7”) further to Example 1, each of the contactor elements comprises a mating surface such that, when the DAC device is modified, the mating surface of each of the contactor elements forms a nested configuration with respect to the mating surface of an adjacent contactor element.

In another example (“Example 8”) further to Example 7, the mating surface is defined by a plurality of enlarged portions protruding from a surface of the contactor element such that each of the contactor elements is shifted out of phase with respect to the adjacent contactor element.

In another example (“Example 9”) further to Example 7, the mating surface is defined by a plurality of surface features formed on a surface of the contactor element such that each of the plurality of surface features of the contactor element is nested with respect to a corresponding one of the plurality of surface features of the adjacent contactor element.

In another example (“Example 10”) further to Example 9, the plurality of surface features include one or more of: pleats, corrugations, or depressions.

In another example (“Example 11”) further to Example 1, the device further includes a housing in which the contactor elements are disposed. The housing is modifiable between a first configuration in which the total volume of the DAC device has a reduced volume and a second configuration in which the total volume of the DAC device has an increased volume greater than the reduced volume.

In another example (“Example 12”) further to Example 11, the housing includes at least one spacing adjustment component.

In another example (“Example 13”) further to Example 12, the at least one spacing adjustment component is an adjustable housing wall that is adjustable to change the total volume of the DAC device within the housing between the reduced volume and the increased volume.

In another example (“Example 14”) further to Example 12, the at least one spacing adjustment component is a single adjustable separator separating an inner volume of the housing into: (a) a first volume defining a total volume of a first set of contactor elements, and (b) a second volume defining a total volume of a second set of contactor elements. The first volume and the second volume are reciprocal with respect to each other such that the separator is adjustable to facilitate either: (1) increasing the first volume and decreasing the second volume, or (2) decreasing the first volume and increasing the second volume.

In another example (“Example 15”) further to Example 11, the housing comprises a flexible frame that is compressible to change the total volume of the DAC device.

In another example (“Example 16”) further to Example 11, the housing comprises a first housing component and a second housing component slidably receivable within the first housing component to reduce the total volume of the DAC device.

In another example (“Example 17”) further to any one of Examples 1-16, each of the contactor elements comprises a sorbent material composite article having: (a) an adsorptive configuration in which the sorbent material composite article is disposed to adsorb one or more components of a feed stream, and (b) a desorptive configuration in which the sorbent material composite article is disposed to remove the one or more components from the sorbent material composite article. The sorbent material composite article comprises a composite of a sorbent and a flexible porous material to facilitate a transfiguration between an adsorptive configuration and a desorptive configuration of the sorbent material composite article.

In another example (“Example 18”) further to Example 17, the sorbent material composite article is flexibly expandable to form the desorptive configuration and flexibly compressible to form the adsorptive configuration.

In one example (“Example 19”), a system is disclosed which includes the DAC device further to any one of Examples 1-17, as well as a sensor that detects an environmental condition, a force application device that applies a force to change the total volume defined by the contactor volumes and the spacing volumes, and a controller that receives the detected environmental condition from the sensor and determine an amount of force applied by the force application device based on the environmental condition.

In another example (“Example 20”) further to Example 19, the system further includes a spacing apparatus that adjusts the plurality of spacings simultaneously and proportionally responsive to the force applied by the force application device.

In another example (“Example 21”) further to Example 19 or 20, the environmental condition includes at least one of: wind speed, humidity, or a pressure drop between an inlet and an outlet of the DAC device.

In one example (“Example 22”), a DAC device includes a housing, a continuous sheet of sorbent material composite article disposed within the housing, the continuous sheet having a length that is modifiable to form at least one rolled portion which facilitates desorption of one or more components of a feed stream and an unrolled portion adjacent to the rolled portion which facilitates adsorption of the one or more components of the feed stream, and a plurality of rollers that are disposed within the housing and contact a plurality of different sections along the length of the continuous sheet to modify the continuous sheet to change a configuration of each of the rolled and unrolled portions.

In another example (“Example 23”) further to Example 22, the housing comprises a desorption section housing therein the rolled portion of the continuous sheet and an adsorption section housing therein the unrolled portion of the continuous sheet.

In another example (“Example 24”) further to Example 23, the DAC device further includes a heating device that applies heat and vacuum only to the desorption section of the housing.

In another example (“Example 25”) further to any one of Examples 22-24, the continuous sheet is modifiable to form two rolled portions and the unrolled portion extending therebetween.

In another example (“Example 26”) further to any one of Examples 22-25, a portion of the plurality of rollers modify sections of the unrolled portion of the continuous sheet to straighten and form a zigzag configuration with a spacing located between two adjacent straightened sections of the continuous sheet.

In one example (“Example 27”), a method of controlling a DAC device includes: actuating the DAC device to create a spacing between any two of a plurality of contactor elements aligned with respect to each other to facilitate homogenous drying for the DAC device to receive an air flow. The DAC device facilitates adsorption and desorption of one or more components of the air flow; adjusting the plurality of contactor elements to align with a first direction of the air flow; and readjusting the plurality of contactor elements to align with a second direction of the air flow that is different from the first direction while maintaining the homogenous drying of the plurality of contactor elements.

In another example (“Example 28”) further to Example 27, the method further includes providing, by a sensor, a signal indicative of a change of the air flow from the first direction to the second direction.

In another example (“Example 29”) further to Example 27 or 28, the readjusting is performed at or near real-time.

In another example (“Example 30”) further to Example 29, the real-time adjusting is performed after completing the adsorption of the one or more components of the air flow and before initiating a subsequent desorption of the one or more components of the air flow following the adsorption.

In another example (“Example 31”) further to any one of Examples 27-30, the adjusting and the readjusting include changing the spacing between the plurality of contactor elements.

In another example (“Example 32”) further to Example 31, the DAC device has a total volume that is reducible by reducing the spacing to facilitate the desorption and is expandable by increasing the spacing to facilitate the adsorption.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIGS. 1A and 1B are illustrations of a DAC device as viewed from the side, according to embodiments disclosed herein, in adsorptive configuration and desorptive configuration.

FIGS. 2A and 2B are side views of a spring-implemented DAC device, according to embodiments disclosed herein, in adsorptive configuration and desorptive configuration.

FIG. 2C is an angled view of leaf spring spacers as used in the DAC devices of FIGS. 2A and 2B.

FIGS. 3A and 3B are side views of a spring-implemented DAC device, according to embodiments disclosed herein, in adsorptive configuration and desorptive configuration.

FIG. 3C is an angled view of a spring coil as used in the DAC devices of FIGS. 3A and 3B.

FIGS. 4A and 4B are side views of a hinge-implemented DAC device, according to embodiments disclosed herein, in adsorptive configuration and desorptive configuration.

FIGS. 5A through 5C are side views of a DAC device with enlarged portions, according to embodiments disclosed herein, in adsorptive configuration (in-phase and out-of-phase) and desorptive configuration.

FIGS. 6A and 6B are side views of a DAC device with surface features, according to embodiments disclosed herein, in adsorptive configuration and desorptive configuration.

FIGS. 7A and 7B are side views of a DAC device with latticed construct, according to embodiments disclosed herein, in adsorptive configuration and desorptive configuration.

FIGS. 8A and 8B are top-down views of a DAC device implementing a continuous sheet of sorbent material composite article, according to embodiments disclosed herein, showing adsorption portion and desorption portion.

FIG. 8C is a top-down view of the sheet wrapped around the porous drum as implemented in the DAC device of FIGS. 8A and 8B according to embodiments disclosed herein.

FIGS. 9A and 9B are side views of a reciprocal DAC device, according to embodiments disclosed herein, showing adsorption portion and desorption portion.

FIGS. 10A and 10B are side views of a reciprocal DAC device, according to embodiments disclosed herein, showing adsorption portion and desorption portion.

FIGS. 11A and 11B are side views of a DAC device with flexible housing, according to embodiments disclosed herein, in adsorptive configuration and desorptive configuration.

FIGS. 12A and 12B are side views of a DAC device with nestable housing, according to embodiments disclosed herein, in adsorptive configuration and desorptive configuration.

FIGS. 13A and 13B are block diagrams of examples of a system implementing a DAC device, according to embodiments disclosed herein.

FIGS. 14A and 14B are side views of an actuator for a DAC device, according to embodiments disclosed herein, in adsorptive configuration and desorptive configuration.

FIGS. 15 and 16 are flowcharts of examples of a method of operating a controller as implemented in the system of FIG. 13A or 13B, according to embodiments disclosed herein.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

The term “fibril” as used herein describes an elongated piece of material such as a polymer, where the length and width are substantially different from each other. For example, a fibril may resemble a piece of string or fiber, where the width (or thickness) is much shorter or smaller than the length.

The term “node” as used herein describes a connection point of at least two fibrils, where the connection may be defined as a location where the two fibrils come into contact with each other, permanently or temporarily. In some examples, a node may also be used to describe a larger volume of material than a fibril and where a fibril originates or terminates with no clear continuation of the same fibril through the node. In some examples, a node has a greater width but a smaller length than the fibril.

As used herein, “nodes” and “fibrils” may be used to describe objects that are usually, but not necessarily, connected or interconnected, and have a microscopic size, for example. A “microscopic” object may be defined as an object with at least one dimension (width, length, or height) that is substantially small such that the object or the detail of the object is not visible to the naked eye or difficult, if not impossible, to observe without the aid of a microscope (including but not limited to a scanning electron microscope or SEM, for example) or any suitable type of magnification device.

### Description of Various Embodiments

The present disclosure relates to devices for use in direct air capture (DAC) to adsorb and separate one or more desired substances from a source stream, such as carbon dioxide (CO₂) from a dilute feed stream, such as air. Such DAC devices may also be used in other adsorbent methods and applications. These methods include, but are not limited to, adsorption of substances from various inputs, including other gas feed streams (e.g., combustion exhaust) and liquid feed streams (e.g., ocean water). The adsorbed substance is not limited to CO₂. Other adsorbed substances may include, but are not limited to, other gas molecules (e.g., N₂, CH₄, and CO), liquid molecules, and solutes. In certain embodiments, the input may be dilute, containing on the order of parts per million (ppm) of the adsorbed substance.

An example of articles and techniques for DAC includes using an article including a substrate such as a monolith that can support or be coated with a sorbent material. Variations are established by changing the type of substrate and the sorbent that is used. However, these previously established articles and methods present limitations in the ability to efficiently cycle between adsorbing and desorbing states. They also have limitations with respect to the energy required to perform the process.

Many times, swing adsorption is a very energy intense process. Whether Pressure Swing, Temperature Swing or Moisture Swing, energy is needed during many of the phases of operation.

As an example, in Temperature-Vacuum Swing Adsorption (TVSA) for Direct Air Capture (DAC) of CO₂, the adsorption step may require fans to force large volumes of air through an air contactor, such as ceramic monolith or plate-pack having a series of adjacent plates with a spacing therebetween. At a point when the operator deems it useful to begin desorption (usually when the contactor has adsorbed an amount of CO₂), the fans may be turned off or deactivated to terminate the adsorption phase.

Once the adsorption phase terminates, the inlet and outlet of the module are closed, which provides a seal for negative pressure. Next, vacuum may be applied to evacuate air within the module and steam is applied to increase the temperature to the point where the sorbent releases CO₂. This CO₂ is then pumped out of the module space and is further processed to remove humidity. Of the aforementioned processes, the desorption step requires significant energy to heat and then cool the module. During desorption, the temperature in the entire module volume must be increased from ambient (which, depending on geographic location, may be extremely cold) to the temperature which facilitates CO₂ removal from the sorbent. In many cases steam is used for this increase in temperature since steam is efficient at transferring heat to a substance. An object of the present invention is to increase the efficiency of a DAC system by providing a module which is capable of variable volume. As an example, the air contactor or module may have one volume during the adsorption step which allows air to flow through it at a very low pressure, thereby facilitating adsorption of CO₂ and at least a second, reduced volume during the desorption step which provides an energy savings by reducing the amount of volume that needs to be increased in temperature. Reducing the volume will also reduce the energy required to apply negative pressure, although in some cases the negative pressure maybe the force that causes the volume reduction.

Similarly, in moisture swing and pressure swing adsorption processes, it is the desorption step that is typically the most energy intensive. In moisture swing, energy used in moving moisture to the contactor and energy used in drying the contactor once the CO₂ is desorbed from it. In pressure swing, energy is used to apply pressure to the sorbent to cause the CO₂ to release from it. In both cases it may also be beneficial to provide an air contactor or module which is capable of variable volume configurations. Current state air contactors and modules are deficient in this respect.

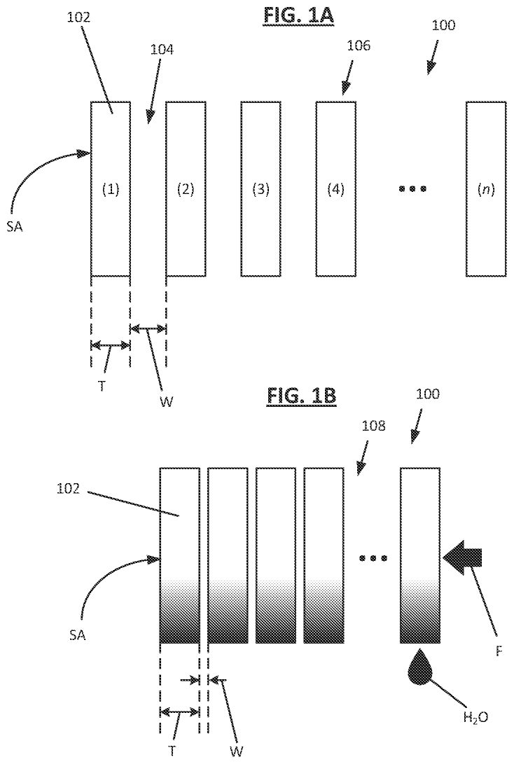

FIGS. 1A and 1B show a DAC device 100 according to an example disclosed herein. The DAC device 100 includes a plurality of contactor elements 102 (numbered as 1, 2, 3, . . . , and n) which are sorbent material composite articles capable of facilitating adsorption and desorption of one or more components of a feed stream (not shown). The feed stream may be the air passing through the DAC device, and the one or more components may include CO₂ or any other aforementioned gas molecules, for example. The contactor elements 102 are aligned with respect to each other in any suitable configuration to facilitate homogenous drying, that is, the contactor elements 102 are capable of drying at approximately the same rate with respect to each other. Advantageously, homogenous drying capability allows the DAC device 100 to more quickly and efficiently complete each adsorption or desorption cycle, since efficiency of the DAC device is reduced when portions of the contact elements are still wet when the next cycle begins.

The contactor elements 102 have a plurality of spacings 104 located therebetween such that each of the contactor elements 102 defines a contactor volume, and each of the spacings defines a spacing volume. The contactor volume (V_{contactor}) of a single contactor element, in some examples, may be defined as: V_{contactor}=SA*T, where SA is the surface area of the contactor element, and T is the thickness of the contactor element. The spacing volume (V_{spacing}) of a single spacing may be defined, in some examples, as: V_{spacing}=SA*W, where W is the width of the spacing, or the distance between the two adjacent contactor elements defining the spacing. These calculations assumes that all contactor elements are identical, thereby having the same surface area, and disposed parallel to one another. The DAC device 100 has a total volume that is defined as the sum of all the contactor volumes and the spacing volumes. The DAC device 100 is also modifiable to (a) reduce the total volume in order for the contactor elements to facilitate desorption of one or more components of a feed stream, and (b) increase the total volume in order for the contactor elements to facilitate adsorption of the one or more components of the feed stream. In some examples, the spacings 104 are reduced in response to a force (F) applied to the contactor elements 102, for example from an external force application device, as further explained herein.

FIG. 1A illustrates the configuration of the DAC device 100 in which the width (W) of each spacing is larger than the configuration of FIG. 1B. With wider width, the total volume increases to facilitate adsorption, so the configuration in FIG. 1A is referred to as an adsorptive configuration 106 with a reduced volume, while the configuration in FIG. 1B is referred to as a desorptive configuration 108 with an increased volume. In some examples, desorbing the contactor elements 102 may include submerging the contactor elements 102 into a desorption source such as water (or alternatively using steam or heat as the desorption source in some examples) in order to desorb the CO₂. In FIG. 1B, the contactor elements 102 are shown as partially black and partially white, to represent the homogenous drying. Black section indicates the presence of moisture or water (H₂O), and the white section indicates dryness. Therefore, the DAC device 100 in the shown example facilitates homogenous drying by positioning each the contactor elements 102 to be substantially vertical with respect to each other, or also referred to being aligned horizontally with respect to each other, such that water is allowed to drip downward via gravity from each contactor element 102 without having the moisture transferred to a neighboring contactor element. As such, the configuration not only facilitates quick drying but also allows each contactor element 102 to dry at the substantially same rate as the other contactor elements 102.

The contactor elements 102 may be formed using any suitable material such as expanded polytetrafluoroethylene (ePTFE), expanded polyethylene (ePE), polytetrafluoroethylene (PTFE), or any other suitable porous material. For example, the porous material may be rigid or flexible, for example ceramic, cellulose, or carbon fiber, etc. In some examples, the porous material may be a porous polymer. It will be appreciated that non-woven materials such as nanospun, meltblown, spunbond and porous cast films could be among the various other suitable porous polymer forms. The contactor elements 102 may be expanded by stretching the material at a controlled temperature and a controlled stretch rate, causing the material to fibrillate. Following expansion, the contactor elements 102 may comprise a microstructure of a plurality of nodes and a plurality of fibrils that connect adjacent nodes to include pores bordered by the fibrils and the nodes. An exemplary node and fibril microstructure is described in U.S. Pat. No. 3,953,566 to Gore, incorporated herein by reference in its entirety. The pores of the contactor elements 102 may be considered micropores. Such micropores may have a single pore size or a distribution of pore sizes. The average pores size may range from 0.1 microns to 100 microns in certain embodiments.

In various embodiments, the contactor elements 102 further includes any suitable carbon dioxide adsorbing material which may include, but is not limited to, an ion exchange resin (e.g., a strongly basic anion exchange resin such as Dowex™ Marathon™ A resin available from Dow Chemical Company), zeolite, activated carbon, alumina, metal-organic frameworks, polyethyleneimine (PEI), or another suitable carbon dioxide adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imidazolate framework and metal organic framework (MOF) adsorbent compounds, and combinations thereof.

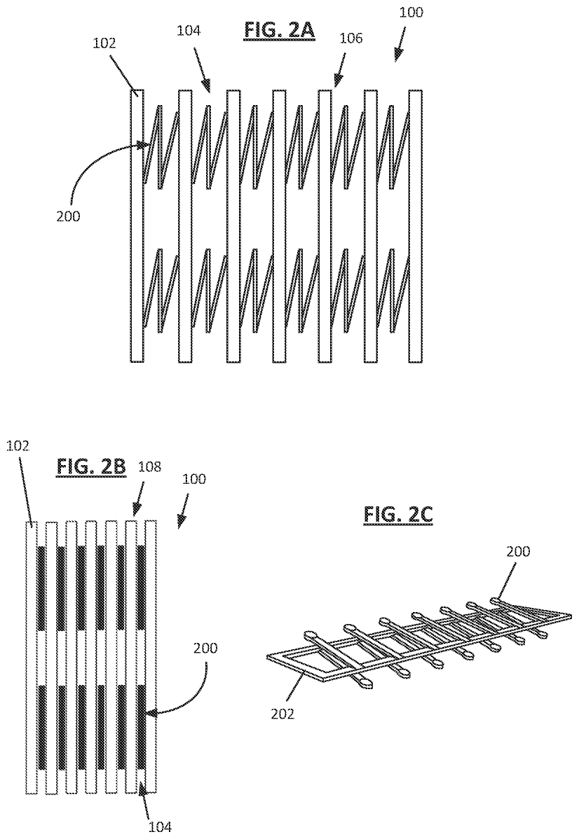

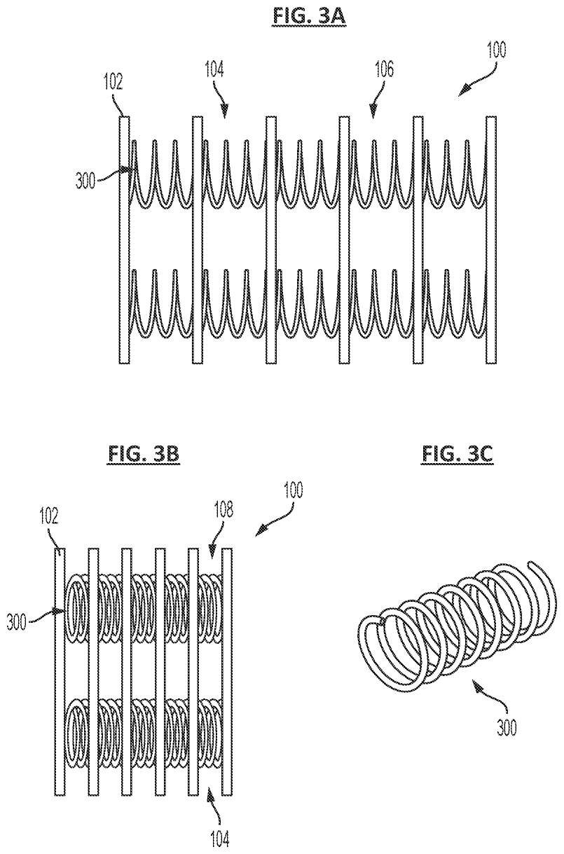

FIGS. 2A and 2B show an example of the DAC device 100 with each of the contactor elements 102 connected to at least one other contactor element 102 using a plurality of flexible connection components disposed in the plurality of spacings 104. The flexible connection components in this example are leaf spring spacers 200 which may be connected to and extending from a frame body 202 similar to cantilevers as shown in FIG. 2C, according to some examples. The leaf spring spacers 200 are expandable to widen the spacings 104 for the DAC device 100 to assume the adsorptive configuration 106, and are also compressible to narrow the spacings 104 to assume the desorptive configuration 108. In some examples, the flexible connection components may be coil springs 300, as shown in FIGS. 3A and 3B, with an example of the coil spring 300 shown in FIG. 3C. In either case, the flexible connection components should be minimal (contributing minimally to the total and thermal mass while minimally impeding airflow)

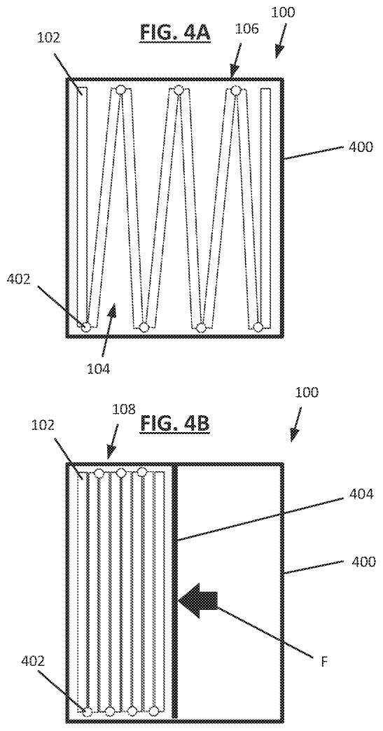

FIGS. 4A and 4B show an example of the DAC device 100 in which the flexible connection components may be hinge components 402. The hinge components 402 allow for non-flexible materials (that is, rigid material which may not be capable of bending, for example) to be used as the contactor elements 102. Furthermore, the DAC device 100 may be enclosed at least partially in a housing 400. In such example, the hinge components 402 cause the spacings 104 to have a different configuration, since the contactor elements 102 are no longer parallel to one another. Instead, the contactor elements 102 form a zigzag shape with the narrower spacing width found nearest the hinge components 402 and the wider spacing width found farthest from the hinge components 402, for example.

The housing 400 may be configured such that there is minimal spacing between the outer edges of the contactor elements 102 and the inner surface of the housing 400, in which case an inner volume of the housing 400 may be used to define the total volume of the DAC device 100. In some examples, the housing 400 includes a spacing adjustment component, which in the figure is an adjustable housing wall 404 that is adjustable to change the total volume of the DAC device within the housing 400 as shown in FIG. 4B. That is, when the DAC device 100 is in the adsorptive configuration 106 as shown in FIG. 4A, the entire inner volume of the housing 400 may be occupied by the contactor elements 102, in which case the adjustable housing wall 404 is flush with one of the walls of the housing 400. However, when the force F is applied, the adjustable housing wall 404 moves toward the opposing wall, thereby causing the DAC device 100 to assume its desorptive configuration 108 as shown in FIG. 4B.

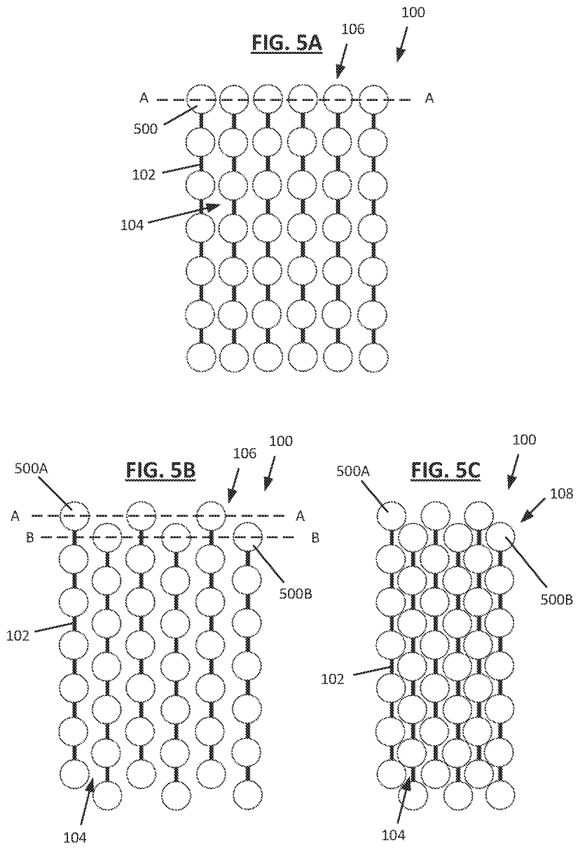

FIGS. 5A through 5C show an example of the DAC device 100 in which the contactor elements 102 are sheets of any suitable porous polymer, as discussed above, having a plurality of enlarged portions 500 protruding from a surface (or both surfaces, as suitable) of the contactor element. In some examples, each of the contactor elements 102 may be shifted out of phase with respect to the adjacent contactor element 102, which is defined as having a different alignment with respect to the adjacent contactor element 102. FIG. 5A shows the contactor elements 102 in an “in-phase” alignment with each other, while FIGS. 5B and 5C show the contactor elements 102 in an “out-of-phase” alignment with each other.

For example, in the adsorptive configuration 106 as shown in FIG. 5B, there are two centerlines A-A and B-B with which the center of the enlarged portion 500 may align. For example, a first enlarged portion 500A from the contactor element 102 may align with the centerline A-A while a second enlarged portion 500B from the adjacent contactor element 102 may align with the centerline B-B. Due to this misalignment, when the DAC device 100 is compressed in the desorptive configuration 108 as shown in FIG. 5C, the enlarged portions 500A and 500B has minimal interference with each other, thereby allowing for a more compact configuration, which beneficially reduces the spacing 104 further to facilitate better desorption. The enlarged portions 500 may assume any suitable shape or configuration, including but not limited to spheres, polygonal structures, cylinders, etc. The surfaces of the enlarged portions 500 and the surfaces of the contactor elements 102 may be considered “mating surfaces” as they form a matching fit or a nested configuration with surfaces of the enlarged portions 505 nested within portions of the adjacent contactor element 102, thereby effectuating a reduction in the total volume of the DAC device 100.

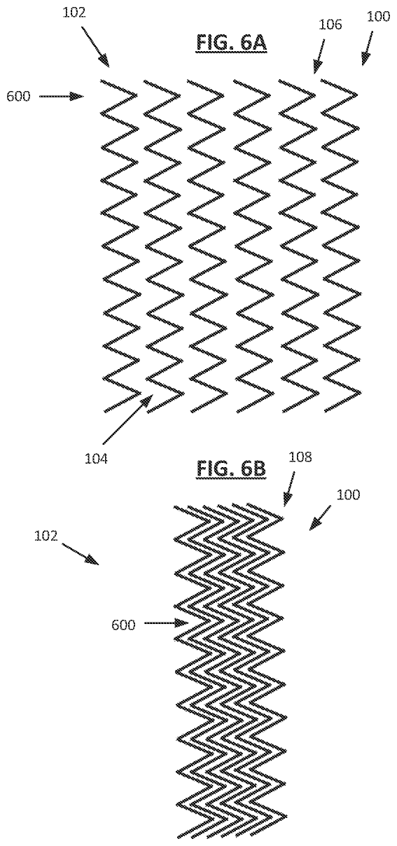

FIGS. 6A and 6B show an example of the DAC device 100 in which the contactor elements 102 are sheets of any suitable porous material, as discussed above, having a plurality of surface features 600 formed on a surface of the contactor element 102 such that each of the plurality of surface features 600 of the contactor element 102 receivably fits, or is nested, with respect to a corresponding one of the plurality of surface features 600 of the adjacent contactor element 102. That is, when transitioning from the adsorptive configuration 106 of FIG. 6A to the desorptive configuration 108 of FIG. 6B, the surface features 600 from adjacent contactor elements 102 may form a coupling with each other such that a protruding portion of one contactor element 102 may fit inside a recessed portion of another contactor element 102, for example. The surface features 600 may include any number or type of features including but not limited to protrusions, recesses, pleats, corrugations, dimples, etc. The surface including the surface features 600 may be considered “mating surfaces” as they form a matching fit or a nested configuration with portions of the adjacent contactor element 102, thereby effectuating a reduction in the total volume of the DAC device 100.

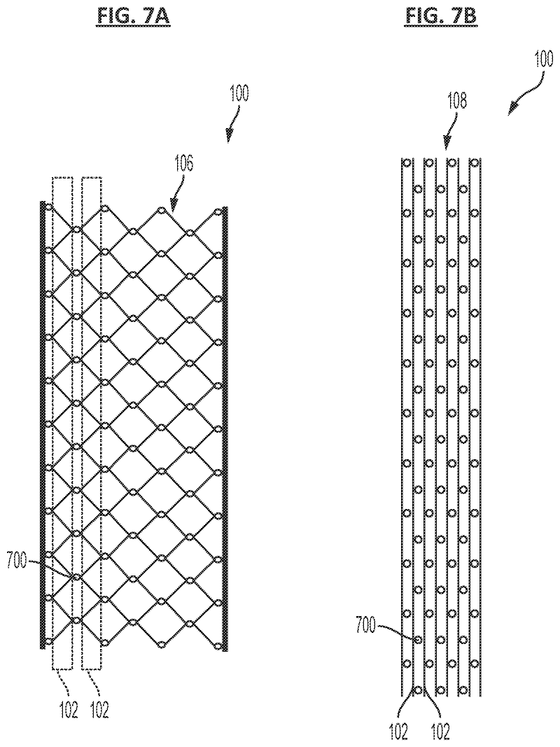

FIGS. 7A and 7B show an example of the DAC device 100 in which connecting components 700 are used with contactor elements 102 which change shape or form between the adsorptive configuration 106 and the desorptive configuration 108. The connection components may be formed via adhesive, stitch, rivet, etc. which attach adjacent contactor elements 102 together. For example, the contactor elements 102 may form a latticed construct having the connecting components 700 to accommodate unfolding (into the adsorptive configuration 106) and folding (into the desorptive configuration 108). In this embodiment, a width of the DAC device 100 is greater in the adsorptive configuration 106 than a width of the DAC device 100 in the desorptive configuration 108. As shown, in the adsorptive configuration 106, the contactor elements 102 may have two different configurations and interconnected via the connecting components 700, and in the desorptive configuration 108, the contactor elements 102 may both be substantially straightened (or folded) in order to reduce the total volume.

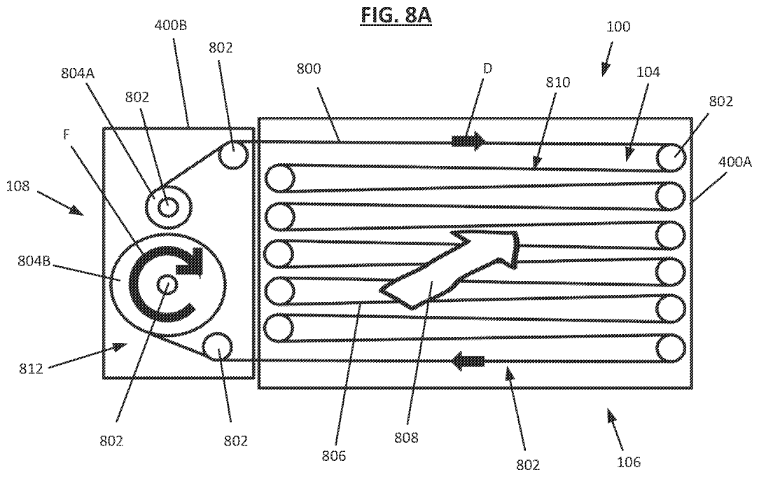

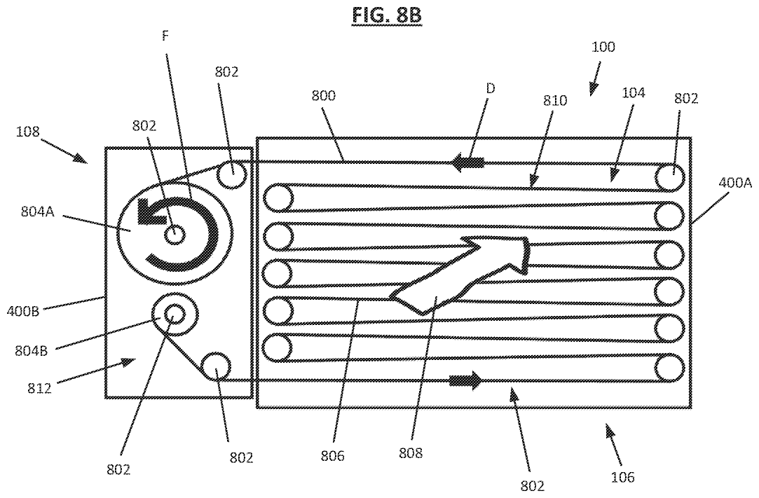

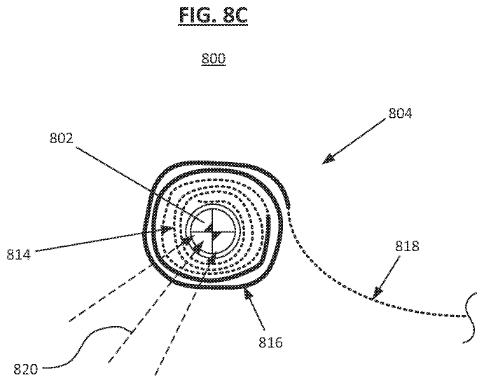

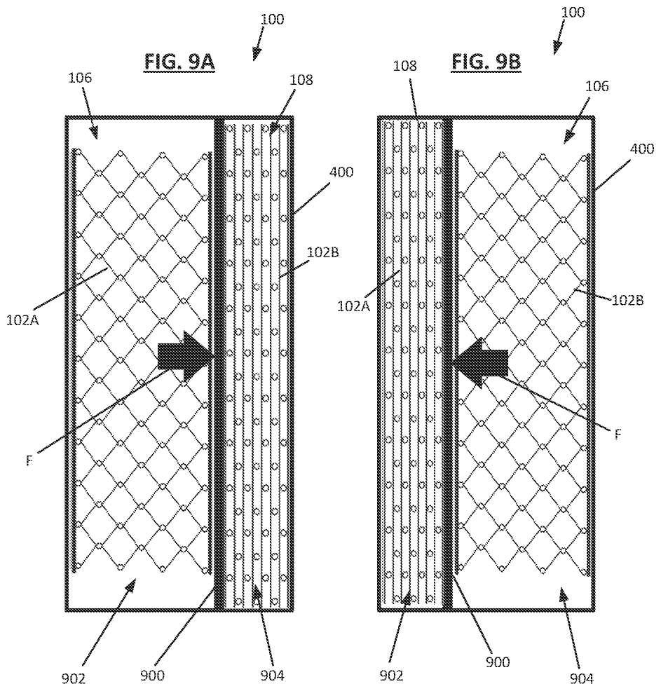

FIGS. 8A and 8B show an example of the DAC device 100, as viewed from the above looking down, in which a continuous sheet 800 of sorbent material composite article is implemented instead of the individual contactor elements 102, where the continuous sheet 800 is arranged in a “moving belt” configuration. The DAC device 100 includes the housing 400 in which the sheet 800 is disposed. The sheet 800 is made of a flexible material and has a length that is modifiable to form at least one rolled portion 804 which facilitates desorption of one or more components of a feed stream 808 and an unrolled portion 806 adjacent to the rolled portion which facilitates adsorption of the one or more components of the feed stream 808.

The DAC device 100 incorporating the sheet 800 includes both the adsorptive configuration 106 and the desorptive configuration 108 in the sheet 800. That is, the sheet 800 experiences adsorption and desorption simultaneously at different portions thereof. For example, the DAC device 100 includes a plurality of rollers 802 disposed within the housing 400 such that these rollers 802 contact a plurality of different sections along the length of the sheet 800 to modify the sheet 800 in order to change a configuration of each of the rolled portion 804 and the unrolled portion 806. The housing 400 includes two sections: the adsorption section 400A where adsorption of the components from the feed stream 808 takes place, and the desorption section 400B where desorption of the components from the feed stream 808 takes place. The sheet 800 can transition between these two sections 400A and 400B of the housing 400.

When the force F is applied to one of the rollers 802 that is coupled with the end portion of the sheet 800, the roller 802 begins turning in a first direction as shown (e.g., clockwise) in FIG. 8A to gather more of the sheet 800 to form the rolled portion 804B around the roller 802. These specific rollers 802 to which the force F can be applied may be referred to as “spool” rollers. Doing this causes the unrolled portion 806 of the sheet 800 to be displaced in a direction “D” as shown. The unrolled portion 806 form a plurality of straightened portions 810 (resembling a zigzag configuration) between two subsequent rollers 802, and the spacing 104 between two adjacent straightened portions 810 allow the adsorption to take place. In FIG. 8B, the force F is applied to the other spool roller 802 in a second direction (e.g., counterclockwise) opposite to the first direction, as shown. This causes the reversal of the direction D of the sheet 800, forming the rolled portion 804A around the spool roller 802 different from the spool roller 802 for the other rolled portion 804B.

In some examples, a space 812 inside the desorption section 400B of the housing 400 may be heated or vacuum may be applied to the space 812, in order to facilitate desorption. In some examples, the heat or vacuum may be applied directly to the rolled portion(s) 804A and/or 804B, which may be achieved using a full drum of spooled sheet 800 as the spool rollers. For example, the drum of sheet 800 may be a porous drum which allows vacuum to be applied, as well as steam and heat, as appropriate.

FIG. 8C illustrates an example of the sheet 800 as implemented with the roller 802 to form the “full drum” as described above. The roller 802 may be a porous drum around which a portion of the sheet 800 is wrapped. Specifically, the sheet 800 has a first porous portion 814 (shown by a dotted line) being rolled onto the porous drum 802, and the sheet 800 also has a non-porous portion 816 (shown by a bold, solid line) being rolled onto the porous portion 814 such that the inner, porous portion 814 is concealed by the outer, non-porous portion 816 to form the rolled portion 804. The non-porous portion allows vacuum to be applied within the porous drum 802. Applying a vacuum or negative pressure is an example of how the desorbed CO₂ may be drawn, although any other suitable method may be implemented as well. The sheet 800 further has a second porous portion 818 (shown by a dotted line) which may extend into the adsorption section 400A of the housing 400. The rolled portion 804 may be exposed to a desorption source 820 such as water, water vapor (steam), and/or heat, for example by injecting the desorption source 820 longitudinally through the center of the rolled portion 804 of the sheet 800. The sheet 800, when unrolled, includes the non-porous portion 816 positioned between the porous portions 814 and 818. In some examples, the portions 814, 816, and 818 are made of attaching two or more different sheets of materials. In some examples, the portions 814, 816, and 818 are integral with each other to form a single continuous and unitary sheet of material. For example, the non-porous portion 816 may be made of a polymer such as PTFE, and the porous portions 814 and 818 may be made of the same polymer but expanded, such as ePTFE.

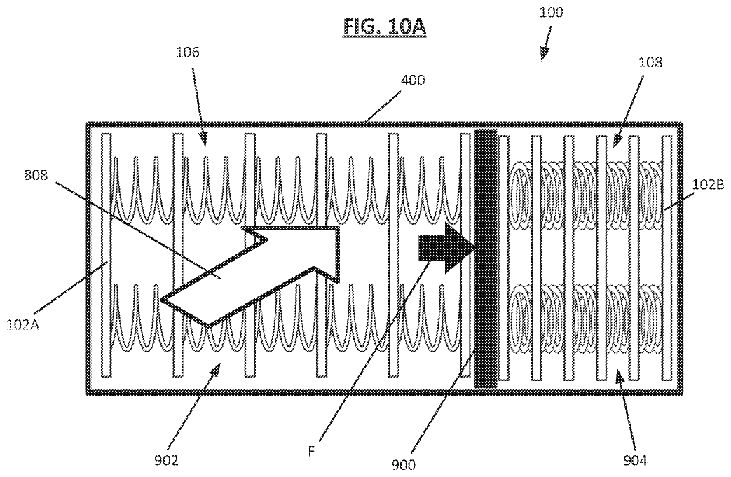

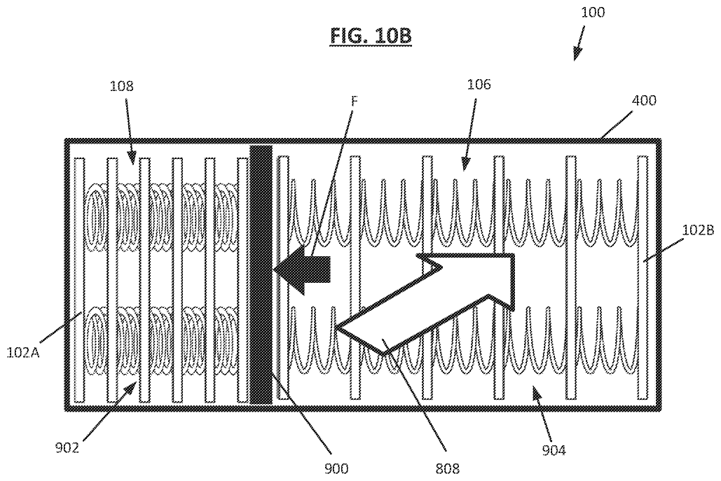

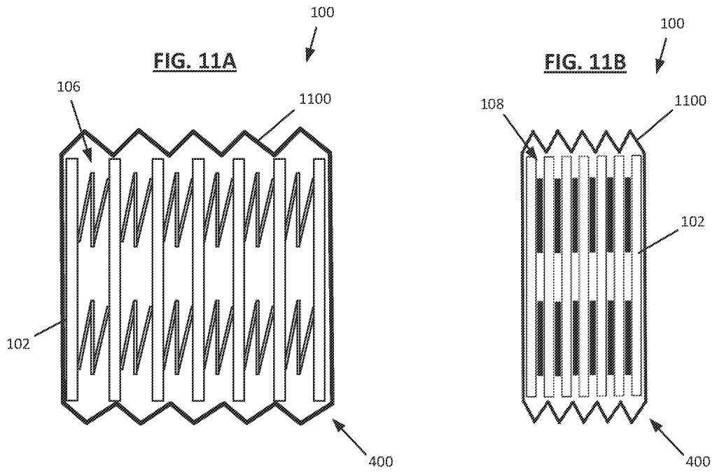

FIGS. 9A, 9B, 10A, and 10B show examples of the DAC device 100 in which both adsorption and desorption takes place simultaneously within the housing 400. That is, the housing 400 includes a single adjustable separator 900 separating an inner volume of the housing 400 into a first volume 902 defining a total volume of a first set of contactor elements 102A and a second volume 904 defining a total volume of a second set of contactor elements 102B. The volumes 902 and 904 of the two sets of contactor elements 102A and 102B, respectively, are reciprocal with respect to each other. The separator 900 can be adjusted to facilitate either (a) increasing the first volume 902 and decreasing the second volume 904, or (b) decreasing the first volume 902 and increasing the second volume 904.

FIGS. 9A and 10A show the force F being applied to move the separator 900 such that the first volume 902 increases while the second volume 904 decreases. This causes the first set of contactor elements 102A to assume the adsorptive configuration 106, while the second set of contactor elements 102B assumes the desorptive configuration 108. Alternatively, FIGS. 9B and 10B show the force F being applied to move the separator 900 in the opposite direction from FIGS. 9A and 10A, respectively, such that the first volume 902 decreases while the second volume 904 increases, so the first set of contactor elements 102A assumes the desorptive configuration 108 while the second set of contactor elements 102B assumes the adsorptive configuration 106. As such, the DAC device 100 can be operated in a continuous fashion, for example allowing one set to dry while the other set performs the adsorption from the feed stream 808.

It is to be understood that, although FIGS. 9A and 9B specifically show the configuration of the contactor elements 102 similar to that as shown in FIGS. 7A and 7B, and FIGS. 10A and 10B specifically show the configuration of the contactor elements 102 similar to that as shown in FIGS. 3A and 3B, the contactor elements 102 are not limited to either of these configurations; in fact, any other configuration (or combination of configurations) of the contactor elements 102 as disclosed herein may be implemented in such reciprocal fashion to facilitate both adsorption and desorption simultaneously, as suitable.

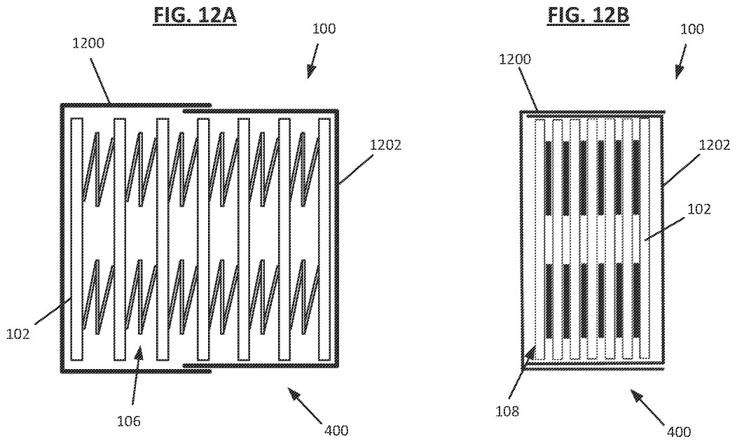

FIGS. 11A and 11B show an example of the DAC device 100 implementing a housing 400 that is at least partially flexible. For example, the housing 400 may have a flexible frame 1100 which is capable of being compressed to change the total volume of the DAC device 100. For example, the flexible frame 1100 may be in the form resembling an accordion (or bellows) such that the corrugated portions at the top and bottom of the flexible frame 1100 (and along the sides, which cannot be seen from the figures) may expand to allow for more volume inside, causing the contactor elements 102 to assume the adsorptive configuration 106, or compress to reduce the volume inside, causing the contactor elements 102 to assume the desorptive configuration 108.

In some examples, the flexible frame 1100 may be made of one or more flexible materials (including but not limited to elastomeric polymers), one or more rigid materials (including but not limited to metals and plastic polymers), or a combination thereof. For example, the corrugated portions of the frame 1100 may be made of a flexible material, while the portion of the frame adjacent to the two contactor elements 102 at the two ends of the DAC device 100 may be made of a rigid material. For example, the corrugated portions of the frame 1100 may be made of a rigid material which can compress or expand using hinge components as disclosed herein. Any other variation or combination of such materials can be used to form the flexible frame 1100.

FIGS. 12A and 12B show an example of the DAC device 100 implementing a housing 400 that can change the internal volume in a nesting or telescoping fashion. That is, the housing 400 includes two components: a first housing component 1200 and a second housing component 1202. The second housing component 1202 is configured to be slightly smaller than the first housing component 1200 such that the second housing component 1202 can be slidably received within the first housing component 1200 to reduce the total volume of the DAC device 100 (causing the contactor elements 102 to assume the desorptive configuration 108), as well as the slidably exit from inside the first housing component 1200 to increase the total volume (causing the contactor elements 102 to assume the adsorptive configuration 106). The housing components 1200 and 1202 can be made of one or more rigid materials such that the shape or configuration of the individual components is maintained in both adsorptive configuration 106 and desorptive configuration 108.

It is to be understood that, although FIGS. 11A, 11B, 12A, and 12B specifically show the configuration of the contactor elements 102 similar to that as shown in FIGS. 2A and 2B, the contactor elements 102 are not limited to either of these configurations; in fact, any other configuration (or combination of configurations) of the contactor elements 102 as disclosed herein may be implemented, as suitable.

As used herein, the DAC devices 100 use contactor elements 102 or continuous sheets 800 that are made of at least one sorbent material composite article, where the article can assume (a) the adsorptive configuration 106 in which the sorbent material composite article is disposed to adsorb one or more components of a feed stream 808, and (b) the desorptive configuration 108 in which the sorbent material composite article is disposed to remove one or more components from the sorbent material composite article. In some examples, the sorbent material composite article may include a composite of a sorbent and a flexible porous material to facilitate a transfiguration between the adsorptive configuration 106 and the desorptive configuration 108 of the sorbent material composite article. In some examples, the sorbent material composite article is flexibly expandable to form the desorptive configuration 108 and flexibly compressible to form the adsorptive configuration 106.

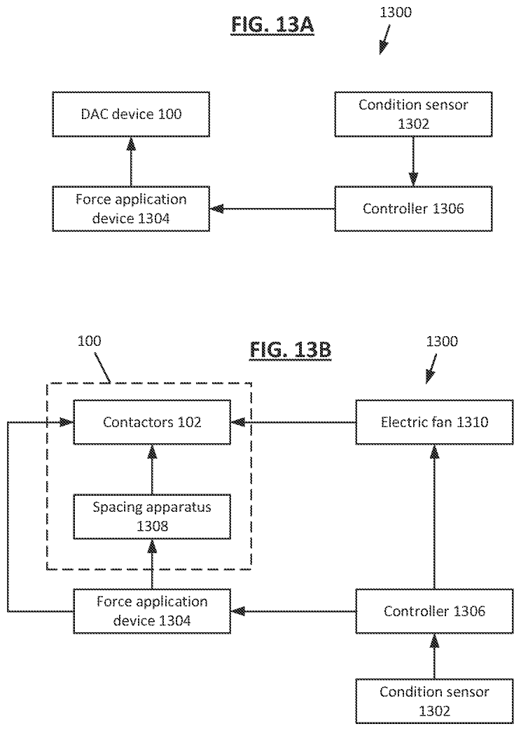

FIGS. 13A and 13B show an example of a system 1300 for implementing the DAC device 100 as disclosed herein. The system 1300 includes, in addition to the DAC device 100, a sensor 1302 which detects an environmental condition(s), a force application device 1304 which applies a force to change the total volume defined by the contactor volumes and the spacing volumes, and a controller 1306 which receives the detected environmental condition(s) from the sensor 1302 and determines an amount of force (that is, force F) applied by the force application device 1304 based on the environmental condition(s). In some examples, the system 1300 may also include an electric fan 1310 to direct air in certain directions, as determined and controlled by the controller 1306. In some applications, the force applied may be air pressure. In the case of positive pressure, the force application device may be a fan (or wind). In the case of negative pressure, the force application device may be a vacuum pump or piston capable of producing vacuum.

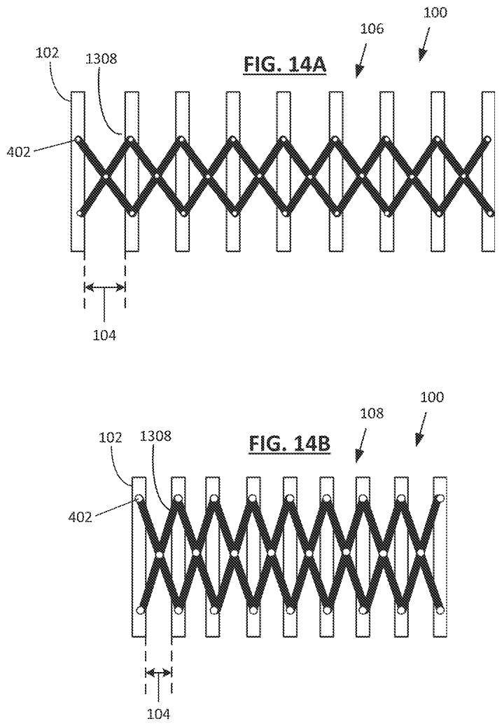

The force application device 1304 can apply the force F either directly to the contactor elements 102 (or the continuous sheets 800 in some examples) or to a spacing apparatus or actuator 1308 coupled to the contactor elements 102 (or continuous sheets 800) and in turn causes the contactor elements 102 to change their positions. For example, the spacing apparatus or actuator 1308 may be a pantograph-type actuator shown in FIGS. 14A and 14B, which also resembles the body portion of a scissor-type extension arm. A hinge component 402 is rotatably coupled with each end of the X-shaped portion of the actuator 1308 (as well as to the center of the X-shaped portion as shown), and the hinge components 402 are also attached to the contactor elements 102.

When the force F is applied either to one of the contactor elements 102 or to the actuator 1308, such as by pinching or closing the X-shaped portion or the rhombus-shaped portion between two adjacent X-shaped portions. As such, even without the use of other flexible connection components such as the leaf spring spacers 200 or the coil springs 300, the actuator 1308 can maintain equal spacing 104 between adjacent contactor elements 102, or adjust the spacings 104 simultaneously and proportionally in response to the force F applied by the force application device 1304. Also, as the actuator 1308 contracts longitudinally (that is, when reducing the total volume of the DAC device 100), it extends latitudinally, thereby causing the contactor elements 102 to expand lengthwise. The actuator 1308 may be made using any suitable rigid material including but not limited to metals or rigid plastic polymers.

The controller 1306 may include one or more computing devices having non-transient computer readable storage media, processors or processing circuits, and communication hardware. The controller 1306 may be a single device or a distributed device, and the functions of the controller may be performed by hardware and/or by processing instructions stored on non-transitory machine-readable storage media. Example processors may include, but are not limited to, an application-specific integrated circuit (ASIC), a field programmable gate array (FPGA), a digital signal processor (DSP), or a microprocessor including firmware. Exemplary non-transitory computer readable storage media may include, but are not limited to, random access memory (RAM), read-only memory (ROM), flash memory, hard disk storage, electronically erasable and programmable ROM (EEPROM), electronically programmable ROM (EPROM), magnetic disk storage, or any other medium which can be used to carry or store processing instructions and data structures and which can be accessed by a general purpose or special purpose computer or other processing device.

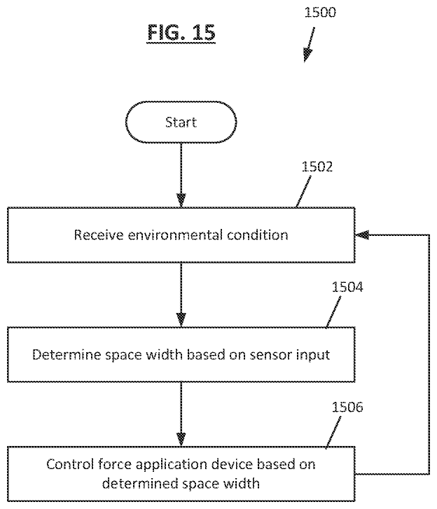

FIG. 15 shows a method 1500 of operating the controller 1306 according to some examples. In step 1502, the controller 1306 receives the environmental condition(s) from the sensor(s) 1302, in response to which, in step 1504, the controller 1306 determines the width of the spacings 104 of the DAC device 100 based on the sensor input. The sensor(s) 1302 may include, but are not limited to, any suitable sensor or sensors capable of detecting one or more of the following: wind speed surrounding or passing through the DAC device 100, humidity surrounding or inside the DAC device 100, and/or a pressure drop (ΔP) between an inlet and an outlet of the DAC device 100. For example, the controller 1306 may determine to increase the width of the spacings 104 when the wind speed is higher than a threshold speed. In some examples, the controller 1306 may determine to change the width of the spacings 104 when the humidity is higher than a higher threshold humidity level or lower than a lower threshold humidity level to achieve an optimum spacing width, which may be determined based on the adsorptive and desorptive properties of the contactor elements 102 being used in the DAC device 100. In some examples, the controller 1306 may determine to change the width of the spacings 104 within the DAC device 100 when the pressure drop ΔP from the inlet to the outlet of the DAC device 100 is higher than a higher threshold pressure differential or lower than a lower threshold pressure differential to achieve the optimum spacing width, in order to improve the efficiency of the contactor elements 102 in adsorbing and desorbing the one or more components of the feed stream 808. In step 1506, the controller 1306 controls the force application device 1304 based on the determined space width in order to achieve the desired space width.

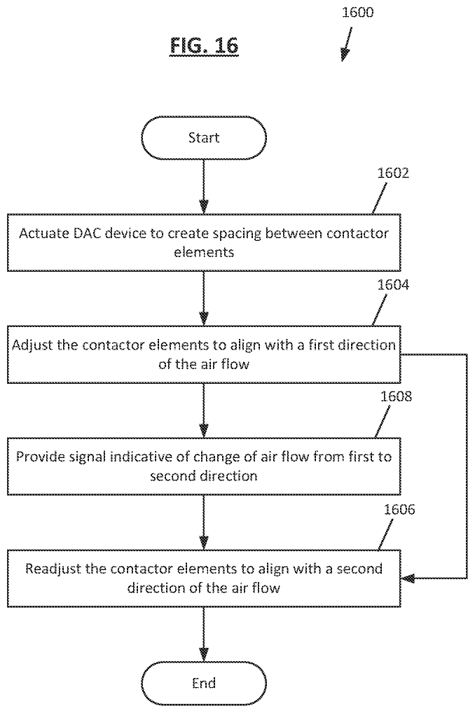

FIG. 16 shows another method 1600 of operating the controller 1306 according to some examples. In step 1602, the controller 1306 actuates the DAC device 100 in order to create a spacing 104 between any two of a plurality of contactor elements 102 aligned with respect to each other to facilitate homogenous drying for the DAC device 100 to receive an air flow (or the feed stream 808). The DAC device 100 facilitates adsorption and desorption of one or more components of the air flow or feed stream 808. In step 1604, the controller 1306 adjusts the plurality of contactor elements 102 to align them with a first direction of the air flow or feed stream 808. In step 1606, the controller 1306 readjusts the plurality of contactor elements 102 in order to align them with a second direction of the air flow or feed stream 808 that is different from the first direction while still maintaining the homogenous drying of the plurality of contactor elements 102.

In some examples, the air flow or feed stream 808 may change directionality over time, such as due to a change in wind direction or other environmental conditions. Therefore, the readjustment performed in step 1606 is to accommodate such change in the environment while still providing the opportunity for the contactor elements 102 to dry in a homogenous way, such that all contactor elements 102 can dry at a relatively equal rate with respect to each other, thus reducing the likelihood of some of the contactors remaining wet and possibly negatively affecting the performance of the other contactors.

In some examples, between steps 1604 and 1606 may be an additional step 1608 in which the sensor 1302 provides a signal indicative of a change of the air flow or feed stream 808 from the first direction to the second direction, thus allowing the adjustment and readjustment to take place based on the sensor measurements. In some examples, the readjustment of step 1606 may be performed at or near real-time. That is, the sensor 1302 constantly provides updated measurement data for the controller 1306 to make changes to the positions of the contactor elements 102 as soon as (or within a reasonably short amount of time from when) the change in the environment is detected. In some examples, the readjustment may be performed in less than 5 seconds, 10 seconds, 30 seconds, 1 minute, 3 minutes, 5 minutes, 10 minutes, or any other suitable range or value therebetween, from when the change in the environment takes place. In some examples, the sensor 1302 may take a reading or measurement at a time interval that is at or less than 5 seconds, 10 seconds, 30 seconds, 1 minute, 3 minutes, 5 minutes, minutes, or any other suitable range or value therebetween.

In some examples, the real-time adjustment of step 1606 may be performed after completing the adsorption of the one or more components of the air flow or feed stream 808 and before initiating a subsequent desorption of the one or more components of the air flow or feed stream 808, following the adsorption. As such, the cycle of adsorption and desorption can be continued without interruption to increase the efficiency of the DAC device 100. As disclosed herein, the adjusting of step 1604 and the readjusting of step 1606 may include changing the spacing 104 between the plurality of contactor elements 102. Furthermore, the DAC device 100 may have a total volume that is reducible by reducing the spacing to facilitate the desorption (in desorptive configuration 108) and is expandable by increasing the spacing to facilitate the adsorption (in adsorptive configuration 106), as disclosed herein.

Beneficially, gas separation by adsorption has many different applications in industry, for example removing a specific component from a gas stream, where the desired product can either be the component removed from the stream, the remaining depleted stream, or both. Thereby, both trace components as well as major components of the gas stream can be targeted by the adsorption process. One important gas separation application is in capturing CO₂ from gas streams, e.g., from flue gases, exhaust gases, industrial waste gases, biogas or atmospheric air. Atmospheric air is considered a dilute feed stream of CO₂. The DAC devices as disclosed herein can facilitate more efficient adsorption and desorption processes by reducing energy requirements (through volume reduction), uniformly drying the contactor elements as well as to facilitate continuous adsorption and desorption with as little downtime as possible.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A direct air capture (DAC) device comprising:
a plurality of contactor elements aligned with respect to each other to facilitate homogenous drying and having a plurality of spacings located therebetween such that each of the contactor elements defines a contactor volume and each of the spacings defines a spacing volume,
the DAC device having a total volume defined by the contactor volumes and the spacing volumes such that the DAC device is modifiable to (a) reduce the total volume for the contactor elements to facilitate desorption of one or more components of a feed stream and (b) increase the total volume for the contactor elements to facilitate adsorption of the one or more components of the feed stream.

2. The DAC device of claim 1, further comprising a plurality of flexible connection components disposed in the plurality of spacings.

3. The DAC device of claim 2, wherein the flexible connection components include one or more of hinge components and spring components that exert reactionary force in response to the total volume being reduced in an opposite direction.

4. The DAC device of claim 3, wherein the spring components comprise one or more of leaf spring spacers and coil springs.

5. The DAC device of claim 1, wherein each of the contactor elements comprises a mating surface such that, when the DAC device is modified, the mating surface of each of the contactor elements forms a nested configuration with respect to the mating surface of an adjacent contactor element.

6. The DAC device of claim 5, wherein the mating surface is defined by a plurality of enlarged portions protruding from a surface of the contactor element such that each of the contactor elements is shifted out of phase with respect to the adjacent contactor element.

7. The DAC device of claim 5, wherein the mating surface is defined by a plurality of surface features formed on a surface of the contactor element such that each of the plurality of surface features of the contactor element is nested with respect to a corresponding one of the plurality of surface features of the adjacent contactor element.

8. The DAC device of claim 7, wherein the plurality of surface features include one or more of: pleats, corrugations, or depressions.

9. The DAC device of claim 1, further comprising:
a housing in which the contactor elements are disposed, wherein the housing is modifiable between a first configuration in which the total volume of the DAC device has a reduced volume and a second configuration in which the total volume of the DAC device has an increased volume greater than the reduced volume.

10. The DAC device of claim 9, wherein the housing includes at least one spacing adjustment component.

11. The DAC device of claim 10, wherein the at least one spacing adjustment component is an adjustable housing wall that is adjustable to change the total volume of the DAC device within the housing between the reduced volume and the increased volume.

12. The DAC device of claim 10, wherein the at least one spacing adjustment component is a single adjustable separator separating an inner volume of the housing into:
a first volume defining a total volume of a first set of contactor elements, and
a second volume defining a total volume of a second set of contactor elements;
wherein the first volume and the second volume are reciprocal with respect to each other such that the separator is adjustable to facilitate either:
increasing the first volume and decreasing the second volume, or
decreasing the first volume and increasing the second volume.

13. The DAC device of claim 9, wherein the housing comprises a flexible frame that is compressible to change the total volume of the DAC device.

14. The DAC device of claim 9, wherein the housing comprises a first housing component and a second housing component slidably receivable within the first housing component to reduce the total volume of the DAC device.

15. The DAC device of claim 1, wherein each of the contactor elements comprises a sorbent material composite article having:
(a) an adsorptive configuration in which the sorbent material composite article is disposed to adsorb one or more components of a feed stream, and
(b) a desorptive configuration in which the sorbent material composite article is disposed to remove the one or more components from the sorbent material composite article,
wherein the sorbent material composite article comprises a composite of a sorbent and a flexible porous material to facilitate a transfiguration between an adsorptive configuration and a desorptive configuration of the sorbent material composite article.

16. The DAC device of claim 15, wherein the sorbent material composite article is flexibly expandable to form the desorptive configuration and flexibly compressible to form the adsorptive configuration.

17. A system comprising:
the DAC device of claim 1;
a sensor configured to detect an environmental condition;
a force application device configured to apply a force to change the total volume defined by the contactor volumes and the spacing volumes; and
a controller configured to receive the detected environmental condition from the sensor and determine an amount of force applied by the force application device based on the environmental condition.

18. The system of claim 17, further comprising:
a spacing apparatus configured to adjust the plurality of spacings simultaneously and proportionally responsive to the force applied by the force application device.

19. The system of claim 17, wherein the environmental condition includes at least one of: wind speed, humidity, or a pressure drop between an inlet and an outlet of the DAC device.

20. A direct air capture (DAC) device comprising:
a housing;
a continuous sheet of sorbent material composite article disposed within the housing, the continuous sheet having a length that is modifiable to form at least one rolled portion which facilitates desorption of one or more components of a feed stream and an unrolled portion adjacent to the rolled portion which facilitates adsorption of the one or more components of the feed stream; and
a plurality of rollers disposed within the housing and configured to contact a plurality of different sections along the length of the continuous sheet to modify the continuous sheet to change a configuration of each of the rolled and unrolled portions.

21. The DAC device of claim 20, wherein the housing comprises a desorption section housing therein the rolled portion of the continuous sheet and an adsorption section housing therein the unrolled portion of the continuous sheet.

22. The DAC device of claim 21, the DAC device further comprising a heating device configured to apply heat and vacuum only to the desorption section of the housing.

23. The DAC device of claim 20, wherein the continuous sheet is modifiable to form two rolled portions and the unrolled portion extending therebetween.

24. The DAC device of claim 20, wherein a portion of the plurality of rollers are configured to modify sections of the unrolled portion of the continuous sheet to straighten and form a zigzag configuration with a spacing located between two adjacent straightened sections of the continuous sheet.

25. A method of controlling a direct air capture (DAC) device, comprising:
actuating the DAC device to create a spacing between any two of a plurality of contactor elements aligned with respect to each other to facilitate homogenous drying for the DAC device to receive an air flow, wherein the DAC device is configured to facilitate adsorption and desorption of one or more components of the air flow;
adjusting the plurality of contactor elements to align with a first direction of the air flow; and
readjusting the plurality of contactor elements to align with a second direction of the air flow that is different from the first direction while maintaining the homogenous drying of the plurality of contactor elements.

26. The method of claim 25, further comprising:
providing, by a sensor, a signal indicative of a change of the air flow from the first direction to the second direction.

27. The method of claim 25, wherein the readjusting is performed at or near real-time.

28. The method of claim 27, wherein the real-time adjusting is performed after completing the adsorption of the one or more components of the air flow and before initiating a subsequent desorption of the one or more components of the air flow following the adsorption.

29. The method of claim 25, wherein the adjusting and the readjusting include changing the spacing between the plurality of contactor elements.

30. The method of claim 29, wherein the DAC device has a total volume that is reducible by reducing the spacing to facilitate the desorption and is expandable by increasing the spacing to facilitate the adsorption.
